(19) United States
(12) Patent Application Publication
(10) Pub. No.: US 2016/0163246 A1
(43) Pub. Date: Jun. 9, 2016

(54) DISPLAY AND METHOD AND SYSTEM FOR COMPENSATING BRIGHTNESS OR COLOR OF DISPLAY

(71) Applicant: Wistron Corporation, New Taipei City (TW)

(72) Inventors: Tsang-Hsing Lee, New Taipei City (TW); Po-Hsu Chen, New Taipei City (TW); Yung-Chih Lin, New Taipei City (TW); Meng-Chao Kao, New Taipei City (TW)

(21) Appl. No.: 14/612,299

(22) Filed: Feb. 3, 2015

(30) Foreign Application Priority Data
Dec. 9, 2014 (TW) 103142811

(51) Int. Cl. G09G 3/20; G09G 3/36

(52) U.S. Cl. CPC G09G 3/2003; G09G 3/3607; G09G 2320/0242; G09G 2320/0233

(57) ABSTRACT

A display and a method and a system for compensating a brightness or a color of the display are provided. In the method, an image of a homogeneous frame displayed on the display is captured by an image capturing device, and a brightness or color distribution of a plurality of pixel values of the captured image is calculated to determine a target value used for adjusting the brightness or the color of the display. Based on the target value, a plurality of gain values of the pixels of the display are calculated by using the pixel values, and recorded in a gain table. The gain table is written to the display. The display inquires the gain values in the gain table to generate a translucent layer, overlap the translucent layer with a current frame to be displayed, and output the overlapped current frame to a display panel for display.

### CROSS-REFERENCE TO RELATED APPLICATION

This application claims the priority benefit of Taiwan application serial no. 103142811, filed on Dec. 9, 2014. The entirety of the above-mentioned patent application is hereby incorporated by reference herein and made a part of this specification.

### BACKGROUND

1. Field

The disclosure relates to a display, and particularly relates to a display and a method and a system for compensating a brightness or a color of the display.

2. Description of Related Art

Backlight modules adopted by most of the conventional liquid crystal displays (LCDs) use light-emitting diodes (LEDs) as the light source and the backlight modules can be categorized into direct-type backlight modules and edge-type backlight modules based on the manner of light incidence. The manufacture of LEDs is a kind of semiconductor manufacture, and requires processes such as epitaxy processes and processes of filling phosphor powder. However, the epitaxy processes and process of preparing phosphor powder inevitably result in differences in voltage, brightness and color on the manufactured LEDs. Thus, LEDs are categorized according to voltage, brightness and color differences and manufactured into LED light bars. In addition, since different LEDs differ from each other with respect to brightness and color, when the difference in brightness and color is so significant that it becomes distinguishable for human eyes, the display is regarded to have an issue of the frame taste. Also, the liquid crystal panels also differ in brightness and color. Thus, after the backlight module and the liquid crystal panel are assembled into an LCD module (LCM), difference in brightness and color between different areas becomes significant.

Even though there are already technologies for compensating the brightness and color, the technologies are implemented to achieve the effect of compensation by using a specific compensating circuit or hardware-in-the-loop to compensate color parameters such as the brightness or the color of the liquid crystal panel and control the currently line of the LEDs in the respective areas.

### SUMMARY

The disclosure provides a display and a method and a system for compensating a brightness and a color of the display capable of compensating for mura of the display without adding a circuit or a hardware-in-the-loop.

A method for compensating a brightness or a color of a display according to the disclosure is suitable for compensating for mura of the display. In the method, an image of the display displaying a homogeneous frame is captured by using an image capturing device, and a brightness or color distribution of a plurality of pixel values of the captured image are calculated to determine a target value for adjusting the brightness or the color of the display. Then, with the target value as a reference, gain values of a plurality of pixels of the display are calculated by using the pixel values and a gain table is established to record the gain values. Then, the gain table is written to the display. The display inquires the gain values of the pixels recorded in the gain table to generate a translucent layer to overlap with a current frame to be displayed, and the current frame is output to a display panel for display.

A system for compensating a brightness or a color of a display according to the disclosure includes a display, an image capturing device, and a processing device. The image capturing device captures an image of the display displaying a homogeneous frame. The processing device is coupled to the display and the image capturing device, and used for calculating a brightness or color distribution of a plurality of pixel values in the image to determine a target value for adjusting the brightness or the color of the display, calculating gain values of a plurality of pixels of the display by using the pixel values with the target value as a reference, establishing a gain table for recording the gain values, and writing the gain table to the display. The display inquires the gain values of the pixels recorded in the gain table to generate a translucent layer to overlap with a current frame to be displayed, and outputs the current frame to a display panel for display.

A display according to the disclosure includes a display panel comprising a plurality of pixels, a storage unit, and a processing unit. The storage unit records a gain table for recording a gain value of each of the pixels of the display panel. The processing unit is coupled to the display panel and the storage unit, and includes a frame receiving module, a screen display module, and a frame overlapping module. The frame receiving module receives a current frame. The screen display module inquires the gain values of the pixels recorded in the gain table to generate a translucent layer accordingly. The frame overlapping module overlaps the translucent layer with a current frame to be displayed and outputs the overlapped current frame to the display panel for display.

A method for compensating a brightness or a color of a display according to the disclosure is adapted for the display having a display panel and a storage unit. In the method, a gain table recorded in the storage unit is accessed to look for gain values of a plurality of pixels of the display panel recorded in the gain table, and accordingly generating a translucent layer. Then, the translucent layer is overlapped with a current frame to be displayed on the display, and the current frame is output to the display panel for display.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating a system for compensating a brightness or a color of a display according to an embodiment of the disclosure.

FIG. 2 is a flowchart illustrating a method for compensating a brightness or a color of a display according to an embodiment of the disclosure.

FIG. 3 is a view illustrating an example of a method for compensating a brightness or a color of a display according to an embodiment of the disclosure.

FIG. 4 is a block view illustrating a display according to an embodiment of the disclosure.

FIG. 5 is view illustrating an example of generating a translucent screen display layer according to an embodiment of the disclosure.

FIG. 6 is a diagram illustrating a relation that a brightness of a display changes with time according to an embodiment of the disclosure.

FIG. 7 is an example that variation of a brightness or a color of a display is compensated with time.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the disclosure, a capturing system is used to capture a whole frame of an LCD module (LCM). A counter-compensating gain table for a brightness and color of the whole frame is generated by using an algorithm, and the gain table is written to the display. Thus, every time the display displays a frame, a gain value of each pixel may be read through a firmware, and an on screen display (OSD) technology is used to generate a translucent screen display layer to overlap with a frame to be displayed. Accordingly, compensation for a mura of the display is made without adding any additional hardware.

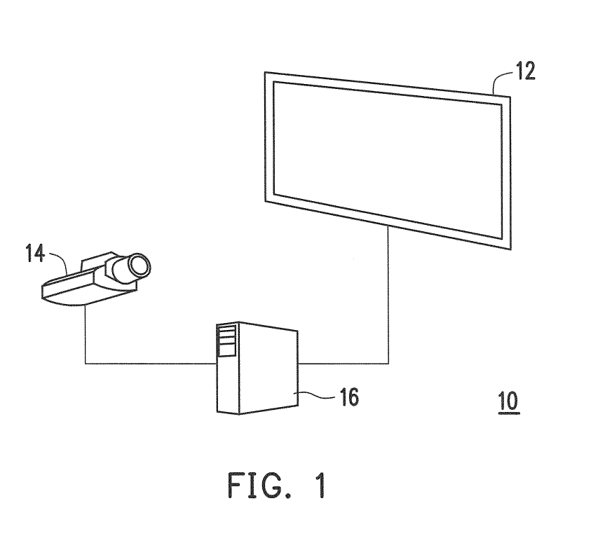

FIG. 1 is a schematic view illustrating a system for compensating a brightness or a color of a display according to an embodiment of the disclosure. Referring to FIG. 1, a system 10 for compensating a brightness or a color of a display in this embodiment includes a display 12, an image capturing device 14, and as processing device 16. Functions of those components are respectively described in the following.

The display 12 is, for example, a screen or a TV using a liquid crystal display (LCD), a light-emitting diode (LED) display, a field emission display (FED), or other kinds of panels as a display panel and using light-emitting diodes as a backlight module. The display 12 receives a frame input from an external device to display the frame on the display panel.

The image capturing device 14 is, for example, a camera or a video camera that includes an optical fixed-focus lens or an optical zooming lens and a photosensitive element such as a charge coupled device (CCD) or a complementary metal-oxide semiconductor (CMOS) device, and is configured to capture an image of the frame on the display 12.

The processing device 16 is, for example, a computer, a work station, or a sever having computing capability. The processing device 16 is, for example, respectively coupled to the display 12 and the image capturing of 14 through transmission interfaces such as a universal asynchronous receiver/transmitter (UART), universal serial bus (USB), or a network port (RJ45) so as to receive the image captured by the image capturing device 44 and analyze the image to establish a gain table for compensating a brightness or a color of the display 12. Moreover, the processing device 16 also writes the established gain table to a memory of the display 12 through the transmission interface to allow the display 12 to compensate for the brightness or the color of the frame displayed on the display 12 accordingly.

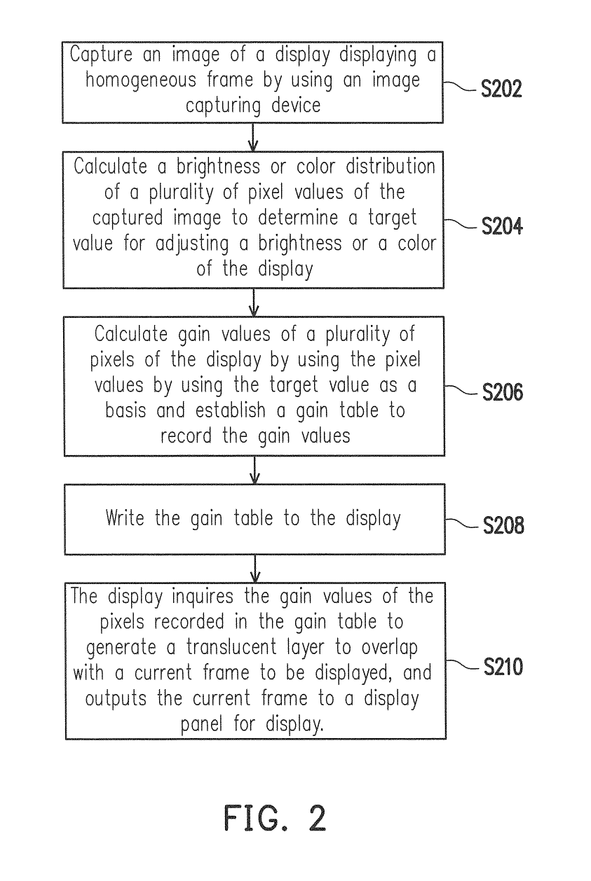

More specifically, FIG. 2 is a flowchart illustrating a method for compensating a brightness or a color of a display according to an embodiment of the disclosure. Referring to FIGS. 1 and 2 together, the method of this embodiment is adapted for the system 10 for compensating the brightness or the color of the display shown in FIG. 1. In the following, details of the method for compensating the brightness or the color of the display are described with reference to the components of the system 10 for compensating the brightness or the color of the display.

First of all, a homogeneous frame displayed on the display 12 is captured by using the image capturing device 14 (Step S202). The homogeneous frame is, for example, a completely white frame, a completely black frame, a gray-scale frame, or other frames allowing to distinguish the brightness or color homogeneity, so as to serve as the basis for compensating for mura of the display 12. After the image capturing device 14 captures the image, the image is, for example, transmitted to the processing device 16 through the transmission interface to allow the processing device 16 to analyze the gain values for compensating the brightness and/or the color of the display 12.

Then, the processing device 16 calculates a brightness or color distribution of a plurality of pixels in the captured image, so as to determine a target value for adjusting the brightness or the color of the display 12 (Step S204). The brightness or color distribution is, for example, a distribution of brightness values or a distribution of chromatic values, but the disclosure is not limited thereto. In addition, the processing device 16 may, for example, select a feature value of the brightness or color distribution as a target value for adjusting the brightness or the color of the display 12. The feature value is, for example, a minimum or an average of all the pixels values, but the disclosure is not limited thereto.

Then, the processing device 16 calculates the gain values of the pixels of the display 12 by using pixel values in the captured image with the target value as a reference, and establishes a gain table to record the gain values (Step S206). In addition, the processing device 16 may calculate a ratio between the target value and each of the pixel values of the captured image as the gain value of the corresponding pixel in the display 12, for example.

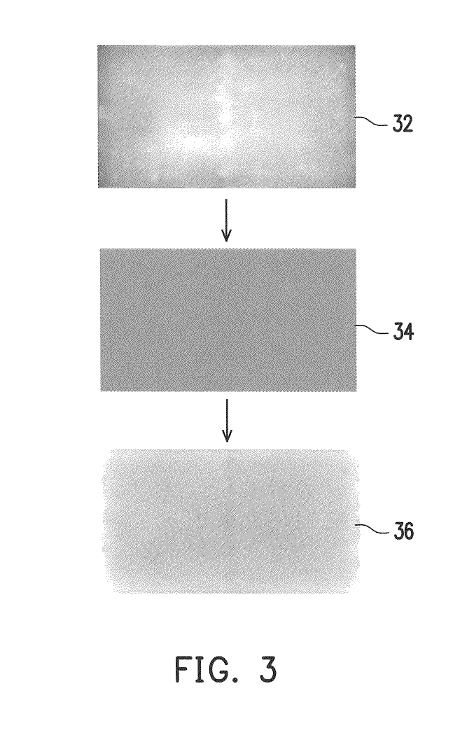

For example, FIG. 3 is an example of a method for compensating a brightness or a color of a display according to an embodiment of the disclosure. Referring to FIG. 3, an image 32 is an image of the display displaying a completely white frame captured by using the image capturing device. By calculating a brightness distribution of the image 32, a maximum (e.g., 471.67) and a minimum (e.g., 284.47) of pixel values of the image 32 are found. In addition with completely white frame, an image signal is only allowed to be tuned down. To make a frame homogeneous after compensation, the target value needs a lower brightness to generate the gain table. In this embodiment, the minimum 284.47) in all the pixel values of the image 32 is used as the target value to generate an image 34 with pixel values of 284.47. In addition, each pixel value (i.e., target value) in the image 32 is divided with a pixel value of a corresponding pixel in the image 34 to obtain a gain value of each of the pixels (shown as image 36).

Back to FIG. 2, after the gain table is established, the processing device 16 writes the gain table to the memory of the display 12 through the transmission interface (Step S208). In this way, every time the display 12 is turned on, the display 12 inquires the pixel gain values recorded in the gain table, generates a translucent layer, overlaps the translucent layer with a current frame to be displayed, and outputs the overlapped current frame to the display panel for display (Step S210). In addition, the display 12 uses the OSD technology, for example, to generate a translucent screen display layer and overlaps the layer with the current frame to be displayed, so as to compensate for the mura of the display 12.

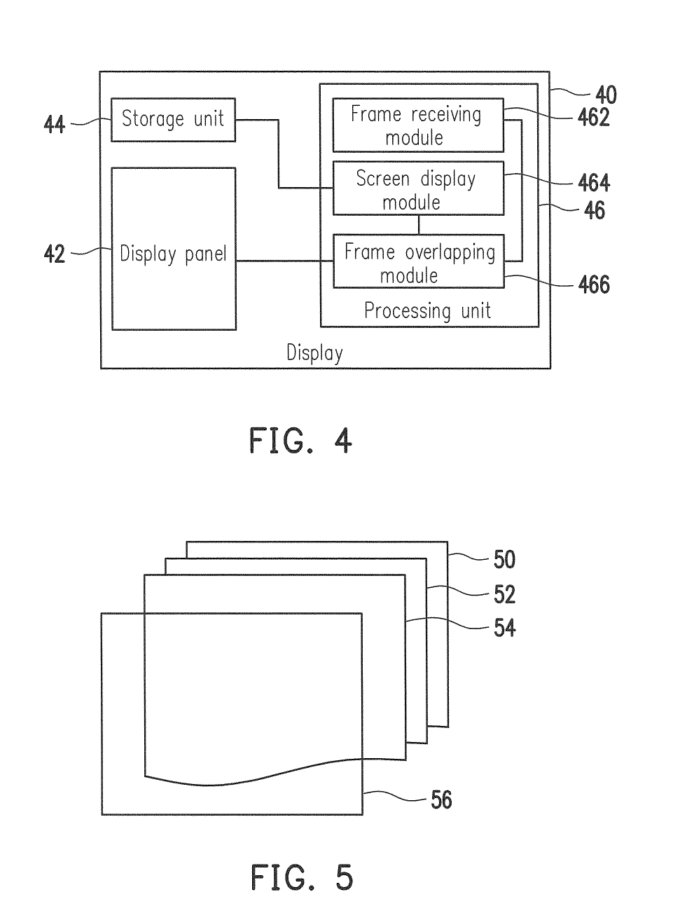

More specifically, FIG. 4 is a block view illustrating a display according to an embodiment of the disclosure. Referring to FIG. 4, a display 40 of this embodiment is a TV or a screen, for example. In addition, the display 42 includes a display panel 42, a storage unit 44, and a processing unit 46. Functions of the components are respectively described in the following.

The display panel 42 is, for example, an LCD panel, an LED panel, a FED panel, or panels of other kinds of displays and is configured to display a frame received by the display 40.

The storage unit 44 is, for example, a non-volatile memory, such as a read only memory (ROM), a programmable ROM, an electrically programmable ROM (EPROM), an electrically erasable and programmable RUM (EEPROM), a flash memory, etc., a hard disk, or a solid state disk (SSD), but the invention is not limited thereto. The storage unit 44 is configured to store a gain table written by the processing device 16 of the embodiment.

The processing unit 46 is, for example, a system-on-a-chip (SoC) including a central processing unit (CPU) or other programmable general-purpose or specific-purpose microprocessors, digital signal processor (DSP), programmable controller, application specific integrated circuit (ASIC), programmable logic device (PLD), or other similar devices or a combination of the aforesaid devices. The processing unit 46 is configured to compensate a brightness or a color of the display 40.

The processing unit 46 includes a frame receiving module 462, a screen display module 464, and a frame overlapping module 466. These modules may be hardware circuits disposed in the processing unit 46 or a firmware to be loaded in the processing unit 46, for example, to compensate for a brightness or a color of a frame received by the display 40.

More specifically, the frame receiving module 462 receives a current frame input from an external device into the display 40 to be displayed on the display panel 42. The frame may further undergo processes such as a brightness or a color space conversion, resolution scaling process, or brightness and contrast adjusting processes, so as to meet a display specification of the display panel 42.

The screen display module 464 inquires the gain table stored in the storage unit 44 to look for the pixel gain values recorded in the gain table, thereby generating the translucent layer. In addition, the screen display module 464 uses the OSD technology to generate the translucent screen display layer, for example. The pixel value of each of the pixels of the translucent layer is, for example, obtained by subtracting a product of a maximum (e.g., 255) of the pixel values and the pixel gain value from the maximum of the pixel values. Accordingly, the mura of the display 40 can be compensated.

For example, FIG. 5 is an example of generating a translucent screen display layer according to an embodiment of the disclosure. Referring to FIG. 5, in this embodiment, the OSD technology is used to overlap a screen display layer 52 for displaying a parameter adjustment interface, a subtitle layer 54 for displaying a subtitle 54, and a translucent layer 56 for compensating for the mura of the display with a video frame layer 50 displayed on the display. By covering the translucent layer 56 on the video frame layer 50, the mura due to a brightness or color difference of the display can be compensated.

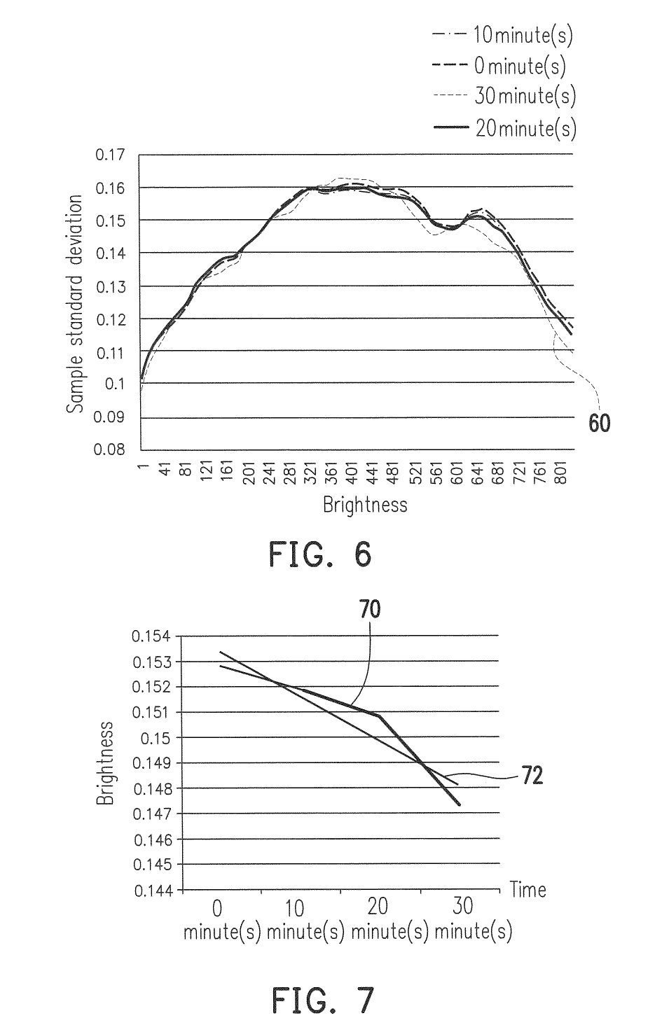

It should be noted that after the display displays a frame for a period of time and the display panel reaches a certain thermal balance, a frame taste of the display may slightly change. This change may also result in the mura of the frame displayed on the display. For example, FIG. 6 is a diagram illustrating a relation that a brightness of a display changes with time according to an embodiment of the disclosure. With a curve 60 shown in FIG. 6 illustrating a relation between a brightness and a sample standard deviation of the display after 30 minutes of display, it is known that the brightness of the display shows a tendency of slight decrease.

Regarding the change above, a time decay function is further implemented in the disclosure to compensate an area whose brightness changes with time. Taking the display 40 shown in FIG. 4 as an example, when generating the translucent layer, besides calculating the pixel values of the translucent layer by using the pixel gain values recorded in the gain table, the screen display module 464 further implements the time decay function in the calculated pixel values, so as to generate the translucent layer whose pixel values change with time. Then, the frame overlapping module 466 overlaps the translucent layer with the frame to be displayed on the display 40. In this way, the change in brightness and color of the display 40 with time can be compensated.

For example, FIG. 7 is an example that variation of a brightness or a color of a display is compensated with time. Referring to FIG. 7, in this embodiment, a trend line 72 is calculated according to a curve 70 showing that the brightness of the display changes with time. Then, a slope of the trend line 72 is calculated, and then the pixel value of each pixel in the translucent layer is compensated according to the slope.

In view of the foregoing, in the display and the method and system for compensating the brightness and color of the display, a counter-compensating gain table for the brightness and the color of the display is established in advance and written to the display. The display may directly read the pixel gain values in the gain table through the firmware, and uses the OSD technology to generate a translucent screen display layer that can cover the frame to be displayed, thereby compensating for the mura of the display. In addition, by implementing a time delay function in calculation of the pixel values of the translucent layer and accordingly generating the translucent layer whose pixel values change with time, the change in brightness and color of the display with time can be compensated.

It will be apparent to those skilled in the art that various modifications and variations can be made to the structure of the present disclosure without departing from the scope or spirit of the invention. In view of the foregoing, it is intended that the present disclosure cover modifications and variations of this disclosure provided they fall within the scope of the following claims and their equivalents.

What is claimed is:

1. A display, comprising:
a display panel, comprising a plurality of pixels;
a storage unit, recording a gain table, wherein the gain table records a gain value of each of the pixels; and
a processing unit, coupled to the display panel and the storage unit, the processing unit comprising:
a frame receiving module, for receiving a current frame;
a screen display module, for inquiring the gain values of the pixels recorded in the gain table to generate a translucent layer accordingly; and
a frame overlapping module, for overlapping the translucent layer with the current frame and outputting the overlapped current frame to the display panel for display.

2. The display as claimed in claim 1, wherein the screen display module further calculates a plurality of pixel values of the translucent layer by using the gain values of the pixels, implements a time decay function to the calculated pixel values, and accordingly generates the translucent layer whose pixel values change with time.

3. A method for compensating a brightness or a color of a display, adapted for the display having a display panel and a storage unit, the method comprising:
accessing a gain table recorded in the storage unit to look for gain values of a plurality of pixels of the display panel recorded in the gain table, and accordingly generating a translucent layer;
overlapping the translucent layer with a current frame to be displayed on the display; and
outputting the current frame to the display panel for display.

4. The method for compensating the brightness or the color of the display as claimed in claim 3, wherein the step of looking for the gain values of the pixels of the display panel recorded in the gain table, and accordingly generating the translucent layer, comprises:
calculating a plurality of pixel values of the translucent layer by using the gain values of the pixels; and
implementing a time decay function to the calculated pixel values to generate the translucent layer whose pixel values change with time.
